(19) United States
(12) Patent Application Publication
(10) Pub. No.: US 2025/0184684 A1
(43) Pub. Date: Jun. 5, 2025

(54) AUDIO REVERBERATION METHOD AND APPARATUS, ELECTRONIC DEVICE AND STORAGE MEDIUM

(71) Applicant: BEIJING CO WHEELS TECHNOLOGY CO., LTD., Beijing (CN)

(72) Inventors: Zheng HUANG, Beijing (CN); Xiaofei GOU, Beijing (CN); Juan LI, Beijing (CN)

(21) Appl. No.: 18/845,026

(22) PCT Filed: Mar. 10, 2023
(86) PCT No.: PCT/CN2023/080932

§ 371 Date: Sep. 9, 2024

(30) Foreign Application Priority Data
Mar. 11, 2022 (CN) 202210238463.6

(51) Int. Cl. H04S 7/00

(52) U.S. Cl. CPC H04S 7/305

(57) ABSTRACT

An audio reverberation method and apparatus, an electronic device, a storage medium, a computer program product, a computer program, and a vehicle. The audio reverberation method comprises: according to a first sound absorption coefficient input by a user, determining a corresponding reverberation parameter (S301); and according to the reverberation parameter, processing a first audio to obtain a reverberation audio (S302). The reverberation parameter comprises at least one of the following: sound velocity, sampling rate, reverberation time, length of impact response, reflection order, delay length, and gain factor.

### CROSS-REFERENCE TO RELATED APPLICATIONS

The present application claims priority to Chinese Patent Application No. 202210238463.6 filed in China on Mar. 11, 2022, the entire content of which is incorporated herein by reference.

### TECHNICAL FIELD

The present disclosure relates to the technical field of audio processing, and particularly to an audio reverberation method and apparatus, an electronic device, a storage medium, a computer program product, a computer program, and a vehicle.

### BACKGROUND

Reverberation is an accumulated result of sound being constantly reflected by interfaces in a space. Increasing the effect of reverberation makes music more soothing and pleasant, which can improve the listening experience of occupants. Existing in-vehicle reverberation systems mainly simulate the listening environment by means of algorithmic virtual reverberation, in which high-cut processing is first performed on the original audio to remove high-frequency signals from the original audio, so as to simulate the reflected sound with the high-frequency signals gone: pre-delay processing is then performed to obtain an impulse response; and the impulse response is subsequently convolved with the original audio to obtain reverberant audio. However, the algorithmic virtual reverberation has severe distortion, and the reverberation effect is relatively poor.

### SUMMARY

To solve the above technical problems or at least some of them, embodiments of the present disclosure provide an audio reverberation method and apparatus, an electronic device, a storage medium, a computer program product, a computer program, and a vehicle, which can reduce the severe distortion of algorithmic virtual reverberation and improve the reverberation effect.

In a first aspect, an embodiment of the present disclosure provides an audio reverberation method, comprising: determining a reverberation parameter according to a first sound absorption coefficient input by a user; and processing a first audio according to the reverberation parameter to obtain a reverberant audio. The reverberation parameter comprises at least one of: a sound speed, a sampling rate, a reverberation time, an impulse response length, an order of reflection, a delay length, and a gain factor.

In some embodiments, before processing the first audio according to the reverberation parameter to obtain the reverberant audio, the method further comprises: pre-processing an original audio to obtain the first audio, the pre-processing comprising at least one of: format conversion, high-cut processing, delay processing, sampling rate conversion, and bit rate adjustment.

In some embodiments, processing the first audio according to the reverberation parameter to obtain the reverberant audio comprises: generating an impulse response according to the reverberation parameter and the first audio; and linearly convolving the impulse response with the first audio to obtain the reverberant audio.

In some embodiments, before determining the reverberation parameter according to the first sound absorption coefficient input by the user, the method further comprises: acquiring a reflected audio signal, the reflected audio signal referring to an audio signal reflected by a material and received after transmission of an original audio signal: calculating a reverberation time of the reflected audio signal: determining, based on the reverberation time, a second sound absorption coefficient corresponding to the material; and storing the material and the second sound absorption coefficient in a corresponding manner in a sound-absorbing material database, the first sound absorption coefficient being any one of sound absorption coefficients in the sound-absorbing material database.

In some embodiments, the first sound absorption coefficient comprises a plurality of sub-sound absorption coefficients, the reverberation parameter comprises a plurality of sets of sub-reverberation parameters, and each of the sub-sound absorption coefficients corresponds to one set of sub-reverberation parameters; and processing the first audio according to the reverberation parameter to obtain the reverberant audio comprises: building an initial reverberation model based on the plurality of sub-sound absorption coefficients, the initial reverberation model comprising a plurality of filters: adjusting parameters corresponding to the plurality of filters according to the plurality of sets of sub-reverberation parameters, where each set of sub-reverberation parameters is used to correspondingly adjust parameters corresponding to one filter; and processing the first audio according to the plurality of filters having undergone parameter adjustment, so as to obtain the reverberant audio.

In some embodiments, the method further comprises: in response to a number of times of the first sound absorption coefficient being greater than or equal to a threshold number of times, determining the first sound absorption coefficient to be a preferred sound absorption coefficient of the user: acquiring, based on having received an audio playback instruction, a second audio corresponding to the audio playback instruction; and processing the second audio by using a preferred reverberation parameter corresponding to the preferred sound absorption coefficient, so as to obtain the reverberant audio.

In some embodiments, before determining the reverberation parameter according to the first sound absorption coefficient input by the user, the method further comprises: receiving a setting instruction from the user: determining a sound-absorbing material indicated by the setting instruction; and looking up the sound-absorbing material database for a sound absorption coefficient corresponding to the sound-absorbing material, and determining the sound absorption coefficient corresponding to the sound-absorbing material to be the first sound absorption coefficient.

In a second aspect, an embodiment of the present disclosure provides an audio reverberation apparatus, comprising a calculation module and a reverberation module.

The calculation module is configured to determine a reverberation parameter according to a first sound absorption coefficient input by a user.

The reverberation module is configured to process a first audio according to the reverberation parameter to obtain a reverberant audio.

The reverberation parameter comprises at least one of: a sound speed, a sampling rate, a reverberation time, an impulse response length, an order of reflection, a delay length, and a gain factor.

In some embodiments, the reverberation module is further configured to: pre-process an original audio to obtain the first audio, where the pre-processing comprises at least one of: format conversion, high-cut processing, delay processing, sampling rate conversion, and bit rate adjustment.

In some embodiments, the reverberation module is specifically configured to: generate an impulse response according to the reverberation parameter and the first audio; and linearly convolve the impulse response with the first audio to obtain the reverberant audio.

In some embodiments, the calculation module is further configured to: acquire a reflected audio signal, the reflected audio signal referring to an audio signal reflected by a material and received after transmission of an original audio signal: calculate a reverberation time of the reflected audio signal: determine, based on the reverberation time, a second sound absorption coefficient corresponding to the material; and store the material and the second sound absorption coefficient in a corresponding manner in a sound-absorbing material database, the first sound absorption coefficient being any one of sound absorption coefficients in the sound-absorbing material database.

In some embodiments, the first sound absorption coefficient comprises a plurality of sub-sound absorption coefficients, the reverberation parameter comprises a plurality of sets of sub-reverberation parameters, and each sub-sound absorption coefficient corresponds to one set of sub-reverberation parameters.

The reverberation module is specifically configured to: build an initial reverberation model based on the plurality of sub-sound absorption coefficients, the initial reverberation model comprising a plurality of filters: adjust parameters corresponding to the plurality of filters according to the plurality of sets of sub-reverberation parameters, where each set of sub-reverberation parameters is used to correspondingly adjust parameters corresponding to one filter; and process the first audio according to the plurality of filters having undergone parameter adjustment, so as to obtain the reverberant audio.

In some embodiments, the reverberation module is further configured to: in response to a number of times of the first sound absorption coefficient being greater than or equal to a threshold number of times, determine the first sound absorption coefficient to be a preferred sound absorption coefficient of the user: acquire, based on having received an audio playback instruction, a second audio corresponding to the audio playback instruction; and process the second audio by using a preferred reverberation parameter corresponding to the preferred sound absorption coefficient, so as to obtain the reverberant audio.

In some embodiments, the calculation module is further configured to: receive a setting instruction from the user: determine a sound-absorbing material indicated by the setting instruction; and look up the sound-absorbing material database for a sound absorption coefficient corresponding to the sound-absorbing material, and determine the sound absorption coefficient corresponding to the sound-absorbing material to be the first sound absorption coefficient.

In a third aspect, an embodiment of the present disclosure provides an electronic device, comprising: a processor, a memory, and a computer program stored on the memory and executable for the processor. The computer program, when executed by the processor, performs the audio reverberation method according to any one of the embodiments of the first aspect.

In a fourth aspect, an embodiment of the present disclosure provides a computer-readable storage medium having a computer program stored thereon. The computer program, when executed by a processor, performs the audio reverberation method according to any one of the embodiments of the first aspect.

In a fifth aspect, an embodiment of the present disclosure provides a computer program product comprising a computer program. The computer program, when executed by a processor, performs the audio reverberation method according to any one of the embodiments of the first aspect.

In a sixth aspect, an embodiment of the present disclosure provides a computer program comprising computer program code. The computer program code, when running on a computer, causes the computer to execute the audio reverberation method according to any one of the embodiments of the first aspect of the present disclosure.

In a seventh aspect, an embodiment of the present disclosure provides a vehicle, comprising: the audio reverberation apparatus according to any one of the embodiments of the second aspect of the present disclosure, or the electronic device according to any one of the embodiments of the third aspect of the present disclosure.

The technical solutions provided in the embodiments of the present disclosure have the following advantages over the related art.

In the present disclosure, the corresponding reverberation parameter is determined by means of the user-customized sound absorption coefficient, and the original audio is processed according to the reverberation parameter, thereby obtaining the reverberant audio. The sound absorption coefficient corresponds to different materials in the actual sound field environment, and the reverberation parameter determined based on the sound absorption coefficient is more accurate. The reverberant audio obtained thereby has high fidelity compared with the existing algorithmic virtual reverberation, and the reverberation effect is improved. Moreover, the user determines the corresponding reverberation parameter by customizing the sound absorption coefficient to simulate the desired listening environment, which enhances the sense of presence when listening, and improves the user experience.

### BRIEF DESCRIPTION OF THE DRAWINGS

The drawings here, which are incorporated into and constitute a part of the specification, illustrate embodiments consistent with the present disclosure and, together with the description, serve to explain the principles of the present disclosure.

To more clearly describe the technical solutions in the embodiments of the present disclosure or the related art, drawings required for describing the embodiments or the related art will be briefly introduced below. Obviously, those of ordinary skill in the art may also obtain other drawings according to these drawings without the exercise of inventive effort.

FIG. 1 is a schematic structural diagram of an existing algorithmic reverberation model;

FIG. 2 is a schematic diagram of an implementation scenario of audio reverberation according to an embodiment of the present disclosure:

FIG. 3 is a flowchart of an audio reverberation method according to an embodiment of the present disclosure:

FIG. 4 is a structural diagram of an audio reverberation apparatus according to an embodiment of the present disclosure; and

FIG. 5 is a structural diagram of an electronic device according to an embodiment of the present disclosure.

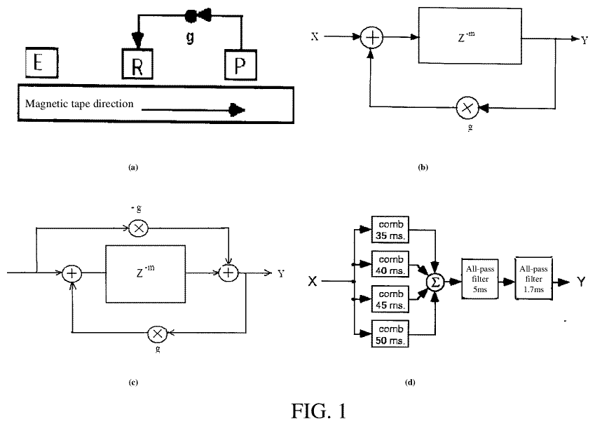

In FIG. 1, (a) is a diagram of the principles of existing simulated reverberation: (b) is a schematic structural diagram of a comb filter: (c) is a schematic structural diagram of an all-pass filter; and (d) is an algorithmic reverberation model that combines comb filtering and all-pass filtering.

### DETAILED DESCRIPTION

To enable clearer understanding of the above objectives, features, and advantages of the present disclosure, the solutions of the present disclosure will be further described below. It should be noted that the embodiments of the present disclosure and the features in the embodiments may be combined with each other where there is no conflict.

In the following description, numerous specific details are set forth to facilitate a thorough understanding of the present disclosure, but the present disclosure may also be implemented in other manners different from those described herein. Obviously, the embodiments in the specification are only some, but not all, of the embodiments of the present disclosure.

To more clearly describe the technical solutions in the embodiments of the present disclosure or the related art, technical terms required for describing the embodiments or the related art will be introduced below:

The generation of reverberation results from sound waves emitted by a sound-producing object and then coming into contact with the surfaces of obstacles through the air so as to be reflected. Due to the complexity of the real-world environment, a sound emitted by a sound source will produce various echoes from various directions. After these sounds are mixed, the so-called reverberation is formed.

A reverberation algorithm refers to constructing a filter by an algorithm to simulate impulse responses of different sound field environments.

Reverberation time, i.e., reverberation time T, refers to the time required, after a sound source stops producing sounds in a closed environment, for residual sound energy to be reflected back and forth and absorbed by a sound-absorbing material in the closed environment, resulting in the sound energy density thereof dropping to one millionth of its original values: or the time required for the sound energy density in the closed environment to decay by 60 dB. A short reverberation time results in dry and dull sound, while a long reverberation time causes the sound to be muddled and unclear and lose a lot of details. A suitable reverberation time can not only beautify sounds and cover up the noise of musical instruments, but also harmonize musical tones to increase loudness and syllable coherence.

FIG. 1(a) is a diagram of the principles of existing simulated reverberation. Reverberation synthesis is implemented in a simulated manner. Such a method is called an audio recorder head feedback method. In early audio recorders, three heads respectively serve as an erase head E, a record head R, and a playback head P, arranged in an order as illustrated in FIG. 1(a). A feedback loop is formed between the playback head P and the record head R, with a feedback factor g. In this way, the sound that is played is constantly delayed, and the sound is constantly attenuated during the delaying, which forms a simple reverberation. The early reverberation algorithm proposed by Bell Laboratories according to the above principle includes two Infinite Impulse Response (IIR) digital filters, i.e., a comb filter and an all-pass filter, which also serve as the basis of current reverberation algorithms.

FIG. 1(b) is a schematic structural diagram of a comb filter. The amplitude attenuation of the impulse response of the comb filter is exponentially distributed, which is consistent with the characteristics of actual room impulse responses. However, the echo density of the comb filter is relatively low and it does not increase with time, which is not consistent with the reality. In addition, spectral characteristics in a periodic or comb-like form may cause apparent coloration in the processed sound. That is, different frequency components are attenuated differently, which is likely to produce a metallic sound that sounds unnatural. The above deficiencies of the comb filter can be overcome by using an all-pass filter.

FIG. 1(c) is a schematic structural diagram of an all-pass filter. As illustrated in the figure, the all-pass filter is composed of a forward path, a backward feedback, and m delays Z^{-m}, where g is a feedback factor of the all-pass filter, and generally g<1.0. X[n] is used to denote a value stored in delay by the filter, where n=0, 1, 2, . . . , m, X[0] denotes a current input, and X[m] denotes an input value before m samples.

Accordingly, the operations of the all-pass storage are as follows:
1. X[0]=the new filter input sample value
2. The forward path X[m]=X[m]+X[0]*(−g), Y[0]=X[m] is a filter output for the current point
3. X[0]=X[0]+X[m]*g
4. X[m]=X[m−1], X[m−1]=X[m−2], . . . , X[1]=X[0]

The frequency response of the all-pass filter is a constant, so that no coloration occurs. However, the echo density of a single all-pass filter is still not high, and a higher echo density can be obtained if a plurality of all-pass filters are connected in series. Since each filter spectrum is all-pass, the overall frequency response remains all-pass after the series connection. Such filters connected in series may be used in situations where the demand on the reverberation effect is not high.

Another method of implementing the algorithmic reverberation model is to combine an all-pass filter with a comb filter. An algorithmic reverberation model combining comb filtering and all-pass filtering is illustrated in FIG. 1(d). As illustrated in the figure, an input signal X passes through four comb filters having delays of 35 ms, 40 ms, 45 ms and 50 ms, respectively, of which outputs are input into an adding circuit. An output of the adding circuit passes through two all-pass filters connected in series that have delays of 5 ms and 1.7 ms. Finally, a result Y is output.

Common disadvantages of the various existing algorithmic reverberation models described above are severe distortion and adversely affected reverberation effects.

In addition, the related art further uses sampling reverberation to simulate the listening environment. First, impulse responses of a certain sound field environment (for example, a theater) are measured on the spot, and then feature extraction is performed. The impulse responses after the feature extraction are convolved with the original audio, thereby obtaining a reverberant audio. This sampling reverberation scheme has high costs because sampling needs to be performed in the actual listening environment, and the effect is monotonous since only the actually sampled listening environment can be simulated.

To solve the above problems, the embodiments of the present disclosure provide an audio reverberation method and apparatus, an electronic device, a storage medium, a computer program product, a computer program, and a vehicle. In the audio reverberation method, a corresponding reverberation parameter is determined by means of a user-customized sound absorption coefficient, and the original audio is processed according to the reverberation parameter, thereby obtaining a reverberant audio. The sound absorption coefficient corresponds to different materials in the actual sound field environment, and the reverberation parameter determined based on the sound absorption coefficient is more accurate. The reverberant audio obtained thereby has high fidelity compared with the existing algorithmic virtual reverberation, and the reverberation effect is improved. Moreover, the user simulates the desired listening environment by customizing the sound absorption coefficient, which improves the listening experience of the user.

In addition, with respect to sampling reverberation, the audio reverberation method provided by the embodiments of the present disclosure, on the one hand, simulates the sound field environment by means of sound absorption coefficients of different materials in the actual sound field environment, thus saving time and effort for measuring different sound field environments on the spot. On the other hand, the method provides the user with a customized sound absorption coefficient, gives the user a degree of freedom to set up the sound field environment, and also increases the diversity of the simulated sound field environment, which is not limited to the actual sound field environment, meets the diversified listening requirements of the user.

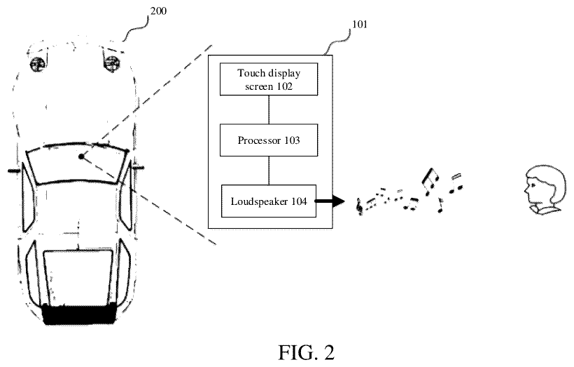

As illustrated in FIG. 2, FIG. 2 is a schematic diagram of an implementation scenario of an audio reverberation method according to an embodiment of the present disclosure. In FIG. 2, an in-vehicle audio system 101 is provided in a vehicle 200. The in-vehicle audio system 101 includes a touch display screen 102, a processor 103, and a loudspeaker 104. A user desires to simulate a sound field environment customized by the user for playing a song in the vehicle 200. For example, the user wants to feel as if they are listening to music in a theater while in the vehicle 200, with the number and materials of facilities such as seats, floors, walls, and stages in the theater being customized by the user. First, the user inputs a first sound absorption coefficient by means of the touch display screen 102, where the first sound absorption coefficient corresponds to a plurality of facilities included in the sound field environment customized by the user. The processor 103 determines a corresponding reverberation parameter according to the first sound absorption coefficient input by the user, and further processes the song according to the reverberation parameter to obtain a song having reverberation effects. Specifically, the processor 103 is configured to determine a reverberation parameter according to a first sound absorption coefficient input by a user; and process a first audio according to the reverberation parameter to obtain a reverberant audio. Herein, the neural network model may be deployed on the processor, so as to determine the reverberation parameter according to the first sound absorption coefficient input by the user. Thus, the song is processed according to the reverberation parameter to obtain a song having reverberation effects. The reverberation effects correspond to the theater customized by the user, meeting the user's needs for diversified listening scenarios.

In some embodiments, the processor may be a computer, a single processor, or a group of processors, and so on. The group of processors may be centralized or distributed, that is, they may be located in one place, or may be distributed to multiple units.

In some embodiments, the neural network model may be deployed in the cloud. The terminal may interact with a cloud server. Through an interaction with the cloud server, the terminal finally obtains the reverberant audio.

The terminals described in the embodiments of the present disclosure may include terminals such as an in-vehicle audio system, a mobile phone, a smart phone, a notebook computer, a digital broadcast receiver, a personal digital assistant (PDA), a tablet computer (PAD), a portable media player (PMP), a navigation apparatus, and the like; and fixed terminals such as a digital TV, a desktop computer, and the like. It should be understood by those skilled in the art that the configuration according to the embodiments of the present disclosure, other than elements specifically used for mobile purposes, can be applied to fixed-type terminals.

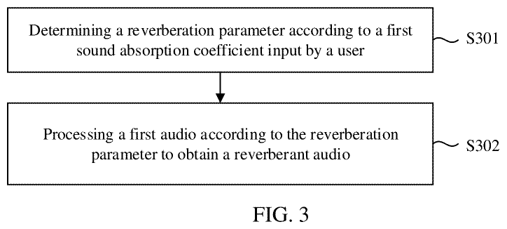

As illustrated in FIG. 3, FIG. 3 is a flowchart of an audio reverberation method according to an embodiment of the present disclosure. The method includes operations at S301 to S302.

At S301, a reverberation parameter is determined according to a first sound absorption coefficient input by a user.

The sound absorption coefficient is the measure of the performance of a sound-absorbing material or a sound-absorbing structure. Different materials have different sound absorption capacities, which are often denoted by α. When α=0, it is indicated that the sound energy is fully reflected and the material does not absorb sounds: when α=1, it is indicated that the material absorbs all the sound energy and there is no reflection. The sound absorption coefficient of a common material ranges from 0 to 1. The larger the sound absorption coefficient α, the better the sound absorption performance of the material.

A calculation formula of the sound absorption coefficient is:

$$α = \frac{{E}_{a} + {E}_{t}}{E} = \frac{E - {E}_{r}}{E} = 1 - r$$

where E is the total sound energy incident onto the material: E_{α} is the sound energy absorbed by the material: Eₜ is the sound energy transmitted through the material: Eᵣ is the sound energy reflected by the material; and r is the order of reflection.

The first sound absorption coefficient may include a sound absorption coefficient corresponding to a material. For example, if the user customizes an empty room constructed with cement walls as the listening environment, the first sound absorption coefficient is a sound absorption coefficient for the cement wall.

The first sound absorption coefficient may further include sound absorption coefficients corresponding to a plurality of materials. The sound absorption coefficient corresponding to each material is a sub-sound absorption coefficient of the first sound absorption coefficient.

In some embodiments, the user desires to listen to songs in a sound field environment simulating a theater, and selects the number of leather-texture seats provided in the theater, a wooden floor, marble walls, and a wooden stage. Accordingly, the first sound absorption coefficient includes: a sound absorption coefficient A for the leather-texture seat, a sound absorption coefficient B for the wooden floor, a sound absorption coefficient C for the marble walls, and a sound absorption coefficient D for the wooden stage. It can be understood that the sound absorption coefficient A for the leather-texture seat, the sound absorption coefficient B for the wooden floor, the sound absorption coefficient C for the marble walls, and the sound absorption coefficient D for the wooden stage are all sub-sound absorption coefficients.

It should be noted that, in the present disclosure, the number of sound absorption coefficients included in the first sound absorption coefficient is not particularly limited, and corresponds to the number input by the user. The user inputs any first sound absorption coefficient to create a sound field environment that does not actually exist.

In some embodiments, the sound absorption coefficient is obtained by measurement. First, an original audio signal with a preset frequency is transmitted to different materials, and then reflected audio signals are acquired. A reflected audio signal refers to an audio signal reflected by a material and received after transmission of the original audio signal. The reverberation time of the reflected audio signal is calculated. Formulas for calculating the reverberation time include, but are not limited to: the Sabine formula, the Eyring formula, and the Eyring-Knudsen formula.

In some embodiments, the Sabine formula is:

$$A = \sum {S}_{i} {α}_{i} + \sum {A}_{j}$$

where αᵢ is a sound absorption coefficient for each material, Sᵢ is the surface area of each material, and Aⱼ is a single sound absorption amount of an indoor object (such as furniture or a person) whose surface area is difficult to determine.

Further, a second sound absorption coefficient corresponding to the material is determined based on the calculated reverberation time. The material and the second sound absorption coefficient are stored in a corresponding manner in a sound-absorbing material database so that, after the user selects a corresponding material, the in-vehicle audio system can find a first sound absorption coefficient corresponding to the material by searching the sound-absorbing material database.

In some embodiments, a setting instruction input by the user through a control is received, a sound-absorbing material indicated by the setting instruction is determined, and the sound-absorbing material database is looked up for a first sound absorption coefficient corresponding to the sound-absorbing material. It can be understood that in the device or apparatus provided by the present disclosure, a selection control for sound-absorbing materials is created in a user interaction interface, the user can customize the sound field environment by means of the selection control, and the setting instruction is generated according to the sound-absorbing material selected by the user.

The reverberation parameter includes at least one of: a sound speed, a sampling rate, a reverberation time, an impulse response length, an order of reflection, a delay length, and a gain factor. The embodiments of the present disclosure include, but are not limited to, the above reverberation parameters, and the reverberation parameter may further include a high-frequency attenuation rate, a cutoff frequency of a low-pass filter, a cutoff frequency of a high-pass filter, and reverberation diffusion.

In some embodiments, the order of reflection r among the reverberation parameters may be determined according to the above calculation formula for the sound absorption coefficient.

The methods for determining the remaining reverberation parameters are not limited in the present disclosure.

In the above embodiment, the sound absorption coefficients of different materials are measured in advance to obtain the sound-absorbing material database, which facilitates the accurate retrieval of the corresponding sound absorption coefficient according to the material in subsequent processes. Further, by configuring controls corresponding to different materials, it is convenient for the user to input materials desired by the user, so as to customize the simulated sound field environment desired by the user, thereby enhancing the interactivity of audio reverberation. In addition, the user customizes the materials included in the sound field environment, so that the reverberation effect is no longer limited to the actually existing sound field environment, thereby improving the scenario adaptability of audio reverberation, and meeting the user's diversified needs.

At S302, a first audio is processed according to the reverberation parameter to obtain a reverberant audio.

Audio is an important medium among multimedia and is in the form of a sound signal.

As a carrier of information, audio may be classified into three types: voice, music, and other sounds. In the embodiments of the present disclosure, the first audio is music, and is at least one piece of music selected by the user from among a plurality of pieces of music.

In some embodiments, before the first audio is processed according to the reverberation parameter, an original audio selected by the user from a music database is obtained and pre-processed. The original audio may also be in a video format.

The pre-processing includes at least one of: format conversion, high-cut processing, delay processing, sampling rate conversion, and bit rate adjustment. In the present disclosure, the order of pre-processing operations is not particularly limited, and the pre-processing may further include: volume adjustment, channel conversion, and noise filtering.

Each pre-processing will be described below.

### (1) Format Conversion:

The file format of the original audio is a file format used to store digital audio data on a computer system. To play or process an audio file in a computer is to perform digital-to-analog conversion on the audio file to obtain a target audio format. This process consists of sampling and quantization. Sampling is to convert a continuous analog audio into a discrete digital audio, and quantization is to convert the discrete digital audio into a digital signal.

The target audio format may be WaveForm (WAV), Windows Media Audio (WMA), Moving Picture Experts Group Audio Layer III (MP3), OGGVobis (OGG), Advanced Audio Coding (AAC), AU, Free Lossless Audio Codec (FLAC), M4A, MKA, Audio Interchange File Format (AIFF), a lossy audio coding format (OPUS), or RealAudio (RA).

As a standard for a digital music file format, the WAV format is excessively large in capacity and is thus inconvenient to use. Therefore, it is typically compressed to a MP3 or AAC format. The compression method includes lossless compression, lossy compression, and hybrid compression.

### (2) High-Cut Processing:

In some embodiments, a band-pass filter is used to perform high-cut processing on the original audio, so as to cut off signals with a cutoff frequency greater than a preset cutoff frequency.

### (3) Delay Processing:

In some embodiments, when delay processing is performed on the original audio, the original audio may be input into a delay processor, and a delay factor is added to the original audio, so as to obtain the first audio.

### (4) Sampling Rate Conversion:

In some embodiments, the more points extracted per unit time, the more abundant the wavelength information obtained. To ensure that the first audio is not distorted, at least 2 points must be sampled in one cycle. The lowest wavelength perceivable by the human ear is 1.7 cm, i.e. 20,000 Hz. Therefore, to meet the auditory requirements of the human ear, sampling is performed at least 40,000 times per 1s, and the sampling rate is 40,000 Hz (40 kHz). The sampling rate of the original audio is converted to a preset sampling rate, e.g., 40 kHz.

In some embodiments, the original audio has a sampling rate of 22.05 kHz. To improve the audio quality, the sampling rate is converted to 44.1 kHz to obtain a first audio with better sound quality.

### (5) Bit Rate Adjustment:

In some embodiments, the bit rate, also called a bitrate, is an indicator that indirectly measures the quality of audio. For example, the bit rate of the original audio is 128 kbps, and the bit rate is adjusted to 256 kbps to obtain a first audio with higher quality.

In the embodiments of the present disclosure, two or more of format conversion, high-cut processing, delay processing, sampling rate conversion, and bit rate adjustment described above may be combined to pre-process the original audio, so as to obtain the first audio.

In some embodiments, format conversion, sampling rate conversion, and bit rate adjustment are performed on the original audio to obtain the first audio, so that the original audio in a file format is converted into the first audio in a data format, which facilitates the subsequent processing. Moreover, the quality of the original audio is improved by setting the sampling rate and the bit rate, thereby obtaining a first audio with better sound quality.

In addition, in other embodiments, a human voice audio signal and an accompaniment audio signal in the original audio are first separated, and then the human voice audio signal and the accompaniment audio signal are separately pre-processed, so that the sound quality of the original audio is improved while the human voice is preserved to the maximum extent.

In other embodiments, pre-processing is separately performed on a left channel audio signal and a right channel audio signal of the first audio, so that the surround effect of the first audio is improved, and the realism of sound field environment simulation is enhanced.

After the first audio is obtained by means of the pre-processing described above, in some embodiments, the first sound absorption coefficient input by the user includes a plurality of sub-sound absorption coefficients. It can be understood that the first sound absorption corresponds to the sound absorption coefficient of the entire sound field environment simulated by the user, and the plurality of sub-sound absorption coefficients correspond to the sound absorption coefficients for the materials of respective facilities in the simulated sound field environment. For example, the first sound absorption coefficient may be an average sound absorption coefficient for a theater, and the plurality of sub-sound absorption coefficients correspond to sound absorption coefficients for a seat material, a floor material, a stage material, and a wall material in the theater.

In the present disclosure, based on actually sampling sound absorption coefficients for different materials, an initial reverberation model is built according to a plurality of sub-sound absorption coefficients, and parameters of a plurality of filters included in the initial model are correspondingly adjusted by using a plurality of sets of reverberation parameters corresponding to the plurality of sub-sound absorption coefficients, where parameters corresponding to one filter can be adjusted according to one set of reverberation parameters. After the plurality of filters having undergone parameter adjustment are obtained, the first audio is input into the plurality of filters to obtain an impulse response. The impulse response is then linearly convolved with the original audio to obtain the reverberant audio.

The plurality of filters in the initial reverberation model include, but are not limited to: a comb (IIR) filter, an all-pass filter, a non-recursive (Finite Impulse Response, FIR) filter, or a combined model of different filters. In the present disclosure, the number of filters is not particularly limited.

In some embodiments, a number of times of the first sound absorption coefficient can be counted, and the first sound absorption coefficient is determined to be a preferred sound absorption coefficient of the user in response to the number of times of the first sound absorption number being greater than or equal to a preset threshold. That is, the user prefers to simulate a sound field environment corresponding to this sound absorption coefficient. Based on having received an audio playback instruction, a second audio corresponding to the audio playback instruction is acquired, and the second audio is processed by using the preferred sound absorption coefficient, so as to obtain the reverberant audio. Therefore, the process of repeatedly determining the reverberation parameter and constructing the filter is reduced. The preferred sound absorption coefficient and the corresponding reverberation model are stored, so that it is convenient for the user to directly perform reverberation for the song when playing the song next time, which meets the user's need to customize the sound field environment for listening, and improves the user's listening experience.

In the above embodiments, after the corresponding reverberation parameter is determined according to the sound absorption coefficient customized by the user, algorithmic reverberation is performed on the first audio, so that the user defines, in the in-vehicle audio system, a sound field environment that does not exist in reality, and freely sets up a user owned listening theater, which gives the user greater room for selection, and makes the audio reverberation more realistic and more diversified.

In summary of the above, the corresponding reverberation parameter is determined by means of the sound absorption coefficient customized by the user, and the original audio is processed according to the reverberation parameter, thereby obtaining the reverberant audio. The sound absorption coefficient corresponds to different materials in the actual sound field environment, and the user simulates the desired listening environment by customizing the sound absorption coefficient, thereby improving the reverberation effect, and enhancing the sense of presence.

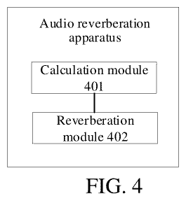

As illustrated in FIG. 4, FIG. 4 is a structural diagram of an audio reverberation apparatus according to an embodiment of the present disclosure. The embodiment of the present disclosure provides an audio reverberation apparatus, including a calculation module 401 and a reverberation module 402.

The calculation module 401 is configured to determine a reverberation parameter according to a first sound absorption coefficient input by a user.

The reverberation module 402 is configured to process a first audio according to the reverberation parameter to obtain a reverberant audio.

The reverberation parameter comprises at least one of:
a sound speed, a sampling rate, a reverberation time, an impulse response length, an order of reflection, a delay length, and a gain factor.

In some embodiments, the reverberation module 402 is further configured to pre-process an original audio to obtain the first audio, where the pre-processing includes at least one of: format conversion, high-cut processing, delay processing, sampling rate conversion, and bit rate adjustment.

In some embodiments, the reverberation module 402 is specifically configured to:
generate an impulse response according to the reverberation parameter and the first audio; and
linearly convolve the impulse response with the first audio to obtain the reverberant audio.

In some embodiments, the calculation module 401 is further configured to:
acquire a reflected audio signal, the reflected audio signal referring to an audio signal
reflected by a material and received after transmission of an original audio signal;
calculate a reverberation time of the reflected audio signal;
determine, based on the reverberation time, a second sound absorption coefficient corresponding to the material; and
store the material and the second sound absorption coefficient in a corresponding manner in a sound-absorbing material database, the first sound absorption coefficient being any one of sound absorption coefficients in the sound-absorbing material database.

In some embodiments, the first sound absorption coefficient includes a plurality of sub-sound absorption coefficients, the reverberation parameter includes a plurality of sets of sub-reverberation parameters, and each sub-sound absorption coefficient corresponds to one set of sub-reverberation parameters.

The reverberation module 402 is specifically configured to:
build an initial reverberation model based on the plurality of sub-sound absorption coefficients, the initial reverberation model including a plurality of filters;
adjust parameters corresponding to the plurality of filters according to the plurality of sets of sub-reverberation parameters, where each set of sub-reverberation parameters is used to correspondingly adjust parameters corresponding to one filter; and
process the first audio according to the plurality of filters having undergone parameter adjustment, so as to obtain the reverberant audio.

In some embodiments, the reverberation module 402 is further configured to: in response to a number of times of the first sound absorption coefficient being greater than or equal to a threshold number of times, determine the first sound absorption coefficient to be a preferred sound absorption coefficient of the user:
acquire, based on having received an audio playback instruction, a second audio corresponding to the audio playback instruction; and process the second audio by using a preferred reverberation parameter corresponding to the preferred sound absorption coefficient, so as to obtain the reverberant audio.

In some embodiments, the calculation module 401 is further configured to:
receive a setting instruction from the user;
determine a sound-absorbing material indicated by the setting instruction; and
look up the sound-absorbing material database for a sound absorption coefficient corresponding to the sound-absorbing material, and determine the sound absorption coefficient corresponding to the sound-absorbing material to be the first sound absorption coefficient.

In summary, the corresponding reverberation parameter is determined by the calculation module according to the sound absorption coefficient customized by the user, and the first audio is processed by the reverberation module according to the reverberation parameter, thereby obtaining the reverberant audio. The sound absorption coefficient corresponds to different materials in the actual sound field environment, and the reverberation parameter determined based on the sound absorption coefficient is more accurate. The reverberant audio obtained thereby has high fidelity compared with the existing algorithmic virtual reverberation, and the reverberation effect is improved. Moreover, the user simulates the desired listening environment by customizing the sound absorption coefficient, thereby enhancing the sense of presence, and improving the user experience.

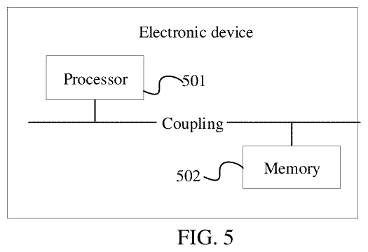

As illustrated in FIG. 5, an embodiment of the present disclosure provides an electronic device, including: a processor, a memory, and a computer program stored on the memory and executable for the processor. The computer program, when executed by the processor, performs each process of the audio reverberation method according to the above method embodiment. The same technical effects can be achieved, and the details are not described here again to avoid repetition.

An embodiment of the present disclosure provides a computer-readable storage medium having a computer program stored thereon. The computer program, when executed by a processor, performs each process of the audio reverberation method according to the above method embodiment. The same technical effects can be achieved, and the details are not described here again to avoid repetition.

The computer-readable storage medium may be a Read-Only Memory (ROM), a Random Access Memory (RAM), a magnetic disk, an optical disk or the like.

An embodiment of the present disclosure provides a computer program product including a computer program. The computer program, when executed by a processor, performs each process of the audio reverberation method according to the above method embodiment. The same technical effects can be achieved, and the details are not described here again to avoid repetition

An embodiment of the present disclosure provides a computer program including computer program code. When running on a computer, the computer program code causes the computer to execute each process of the audio reverberation method according to the above method embodiment. The same technical effects can be achieved, and the details are not described here again to avoid repetition

An embodiment of the present disclosure provides a vehicle including the audio reverberation apparatus according to the above embodiment or the electronic device according to the above embodiment. The vehicle is configured to perform the audio reverberation method provided by any one of the embodiments of the present disclosure. The same technical effects can be achieved, and the details are not described here again to avoid repetition

It should be apparent to those skilled in the art that the embodiments of the present disclosure may be provided as a method, an apparatus, an electronic device, a computer program product, a computer program, and a vehicle. Therefore, the present disclosure may take the form of an entirely hardware embodiment, an entirely software embodiment, or an embodiment combining software and hardware aspects. Furthermore, the present disclosure may take the form of a computer program product implemented on one or more computer-usable storage media having computer-usable program code included therein.

In the present disclosure, the processor may be a Central Processing Unit (CPU), or may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component or the like. The general-purpose processor may be a microprocessor, or the processor may be any conventional processor, etc.

In the present disclosure, the memory may include a non-permanent memory, a random access memory (RAM) and/or a non-volatile memory, and so on among computer-readable media, such as a read only memory (ROM) or a flash memory (flash RAM). The memory is an example of the computer-readable medium.

In the present disclosure, the computer-readable medium includes permanent and non-permanent, removable or non-removable storage medium. The storage medium may be implemented by any method or technology to store information, and the information may be computer-readable instructions, data structures, modules of programs, or other data. Examples of a storage medium for a computer include, but are not limited to, a phase change memory (PRAM), a static random access memory (SRAM), a dynamic random access memory (DRAM), other types of random access memories (RAM), a read only memory (ROM), an electrically erasable programmable read only memory (EEPROM), a flash memory or other memory technology, a compact disc-read only memory (CD-ROM), a digital versatile disc (DVD) or other optical storage, a cassette-type magnetic tape, magnetic disk storage or other magnetic storage devices, or any other non-transmission medium that can be used to store information accessible by a computing device. According to the definition herein, the computer-readable medium does not include transitory computer-readable media such as modulated data signals and carrier waves.

It should be noted that relational terms such as “first” and “second” herein are used only to distinguish one entity or operation from another entity or operation, and do not necessarily require or imply any actual relationship or order between these entities or operations. Moreover, the term “comprise”, “include” or any other variation thereof, is intended to encompass non-exclusive inclusion, so that processes, methods, articles or devices including a series of elements not only include those elements, but also include other elements that are not explicitly listed, or further include the elements inherent to such processes, methods, articles, or devices. In the absence of more limitations, an element defined by the statement “comprising a . . . ” does not preclude the presence of additional same elements in a process, method, article or device that includes the element.

The foregoing is merely specific embodiments of the present disclosure to enable those skilled in the art to understand or implement the present disclosure. Various modifications to these embodiments will be readily apparent to those skilled in the art, and the generic principles defined herein may be implemented in other embodiments without departing from the spirit or scope of the present disclosure. Therefore, the present disclosure is not limited to the embodiments shown herein but rather conforms to the broadest scope consistent with the principles and novel features disclosed herein.

1. A method for audio reverberation, comprising:
determining a reverberation parameter according to a first sound absorption coefficient input by a user; and
processing a first audio according to the reverberation parameter to obtain a reverberant audio.

2. The method according to claim 1, wherein before processing the first audio according to the reverberation parameter to obtain the reverberant audio, the method further comprises:
pre-processing an original audio to obtain the first audio,
wherein the pre-processing comprises at least one of: format conversion, high-cut processing, delay processing, sampling rate conversion, and bit rate adjustment.

3. The method according to claim 1, wherein processing the first audio according to the reverberation parameter to obtain the reverberant audio comprises:
generating an impulse response according to the reverberation parameter and the first audio; and
linearly convolving the impulse response with the first audio to obtain the reverberant audio.

4. The method according to claim 1, wherein before determining the reverberation parameter according to the first sound absorption coefficient input by the user, the method further comprises:
acquiring a reflected audio signal, the reflected audio signal referring to an audio signal reflected by a material and received after transmission of an original audio signal;
calculating a reverberation time of the reflected audio signal;
determining, based on the reverberation time, a second sound absorption coefficient corresponding to the material; and
storing the material and the second sound absorption coefficient in a corresponding manner in a sound-absorbing material database, the first sound absorption coefficient being any one of sound absorption coefficients in the sound-absorbing material database.

5. The method according to claim 1, wherein the first sound absorption coefficient comprises a plurality of sub-sound absorption coefficients, the reverberation parameter comprises a plurality of sets of sub-reverberation parameters, and each sub-sound absorption coefficient corresponds to one set of sub-reverberation parameters; and
processing the first audio according to the reverberation parameter to obtain the reverberant audio comprises:
building an initial reverberation model based on the plurality of sub-sound absorption coefficients, the initial reverberation model comprising a plurality of filters;
adjusting parameters corresponding to the plurality of filters according to the plurality of sets of sub-reverberation parameters, wherein each set of sub-reverberation parameters is used to correspondingly adjust parameters corresponding to one filter; and
processing the first audio according to the plurality of filters having undergone parameter adjustment, so as to obtain the reverberant audio.

6. The method according to claim 1, further comprising:
in response to a number of times of the first sound absorption coefficient being greater than or equal to a threshold number of times, determining the first sound absorption coefficient to be a preferred sound absorption coefficient of the user;
acquiring, based on having received an audio playback instruction, a second audio corresponding to the audio playback instruction; and
processing the second audio by using a preferred reverberation parameter corresponding to the preferred sound absorption coefficient, so as to obtain the reverberant audio.

7. The method according to claim 4, wherein before determining the reverberation parameter according to the first sound absorption coefficient input by the user, the method further comprises:
receiving a setting instruction from the user;
determining a sound-absorbing material indicated by the setting instruction; and
looking up the sound-absorbing material database for a sound absorption coefficient corresponding to the sound-absorbing material, and determining the sound absorption coefficient corresponding to the sound-absorbing material to be the first sound absorption coefficient.

8. (canceled)

9. An electronic device, comprising: a processor, a memory, and a computer program stored on the memory and executable for the processor, wherein the computer program, when executed by the processor, performs operations of:
determining a reverberation parameter according to a first sound absorption coefficient input by a user; and
processing a first audio according to the reverberation parameter to obtain a reverberant audio.

10. A non-transitory computer-readable storage medium, comprising: a computer program stored thereon, wherein the computer program, when executed by a processor, performs operations of:
determining a reverberation parameter according to a first sound absorption coefficient input by a user; and
processing a first audio according to the reverberation parameter to obtain a reverberant audio.

11.-13. (canceled)

14. The method according to claim 1, wherein determining the reverberation parameter according to the first sound absorption coefficient input by the user comprises:
determining, through a neural network model, the reverberation parameter according to the first sound absorption coefficient input by the user.

15. The electronic device according to claim 9, wherein before processing the first audio according to the reverberation parameter to obtain the reverberant audio, the computer program, when executed by the processor, further performs operations of:
pre-processing an original audio to obtain the first audio,
wherein the pre-processing comprises at least one of: format conversion, high-cut processing, delay processing, sampling rate conversion, and bit rate adjustment.

16. The electronic device according to claim 9, wherein when processing the first audio according to the reverberation parameter to obtain the reverberant audio, the processor is specifically configured to:
generate an impulse response according to the reverberation parameter and the first audio; and
linearly convolve the impulse response with the first audio to obtain the reverberant audio.

17. The electronic device according to claim 9, wherein before determining the reverberation parameter according to the first sound absorption coefficient input by the user, the computer program, when executed by the processor, further performs operations of:
acquiring a reflected audio signal, the reflected audio signal referring to an audio signal reflected by a material and received after transmission of an original audio signal;
calculating a reverberation time of the reflected audio signal;
determining, based on the reverberation time, a second sound absorption coefficient corresponding to the material; and
storing the material and the second sound absorption coefficient in a corresponding manner in a sound-absorbing material database, the first sound absorption coefficient being any one of sound absorption coefficients in the sound-absorbing material database.

18. The electronic device according to claim 9, wherein the first sound absorption coefficient comprises a plurality of sub-sound absorption coefficients, the reverberation parameter comprises a plurality of sets of sub-reverberation parameters, and each sub-sound absorption coefficient corresponds to one set of sub-reverberation parameters; and
when processing the first audio according to the reverberation parameter to obtain the reverberant audio, the processor is specifically configured to:
build an initial reverberation model based on the plurality of sub-sound absorption coefficients, the initial reverberation model comprising a plurality of filters;
adjust parameters corresponding to the plurality of filters according to the plurality of sets of sub-reverberation parameters, wherein each set of sub-reverberation parameters is used to correspondingly adjust parameters corresponding to one filter; and
process the first audio according to the plurality of filters having undergone parameter adjustment, so as to obtain the reverberant audio.

19. The electronic device according to claim 9, wherein the computer program, when executed by the processor, further performs operations of:
in response to a number of times of the first sound absorption coefficient being greater than or equal to a threshold number of times, determining the first sound absorption coefficient to be a preferred sound absorption coefficient of the user;
acquiring, based on having received an audio playback instruction, a second audio corresponding to the audio playback instruction; and
processing the second audio by using a preferred reverberation parameter corresponding to the preferred sound absorption coefficient, so as to obtain the reverberant audio.

20. The electronic device according to claim 17, wherein before determining the reverberation parameter according to the first sound absorption coefficient input by the user, the computer program, when executed by the processor, further performs operations of:
receiving a setting instruction from the user;
determining a sound-absorbing material indicated by the setting instruction; and
looking up the sound-absorbing material database for a sound absorption coefficient corresponding to the sound-absorbing material, and determining the sound absorption coefficient corresponding to the sound-absorbing material to be the first sound absorption coefficient.

21. The non-transitory computer-readable storage medium according to claim 10, wherein before processing the first audio according to the reverberation parameter to obtain the reverberant audio, the computer program, when executed by the processor, further performs operations of:
pre-processing an original audio to obtain the first audio,
wherein the pre-processing comprises at least one of: format conversion, high-cut processing, delay processing, sampling rate conversion, and bit rate adjustment.

22. The non-transitory computer-readable storage medium according to claim 10, wherein when processing the first audio according to the reverberation parameter to obtain the reverberant audio, the processor is specifically configured to:
generate an impulse response according to the reverberation parameter and the first audio; and
linearly convolve the impulse response with the first audio to obtain the reverberant audio.

23. The non-transitory computer-readable storage medium according to claim 10, wherein before determining the reverberation parameter according to the first sound absorption coefficient input by the user, the computer program, when executed by the processor, further performs operations of:
acquiring a reflected audio signal, the reflected audio signal referring to an audio signal reflected by a material and received after transmission of an original audio signal;
calculating a reverberation time of the reflected audio signal;
determining, based on the reverberation time, a second sound absorption coefficient corresponding to the material; and
storing the material and the second sound absorption coefficient in a corresponding manner in a sound-absorbing material database, the first sound absorption coefficient being any one of sound absorption coefficients in the sound-absorbing material database.

24. The non-transitory computer-readable storage medium according to claim 10, wherein the first sound absorption coefficient comprises a plurality of sub-sound absorption coefficients, the reverberation parameter comprises a plurality of sets of sub-reverberation parameters, and each sub-sound absorption coefficient corresponds to one set of sub-reverberation parameters; and
when processing the first audio according to the reverberation parameter to obtain the reverberant audio, the processor is specifically configured to:
build an initial reverberation model based on the plurality of sub-sound absorption coefficients, the initial reverberation model comprising a plurality of filters;
adjust parameters corresponding to the plurality of filters according to the plurality of sets of sub-reverberation parameters, wherein each set of sub-reverberation parameters is used to correspondingly adjust parameters corresponding to one filter; and
process the first audio according to the plurality of filters having undergone parameter adjustment, so as to obtain the reverberant audio.
